(19) United States
(12) Patent Application Publication
(10) Pub. No.: US 2026/0243513 A1
(43) Pub. Date: Aug. 20, 2026

(54) SYSTEMS AND METHODS FOR ANNEALING FROZEN BULK IN DYNAMIC BULK FREEZE DRYING

(71) Applicant: Pfizer Inc., New York, NY (US)

(72) Inventor: Matthias PLITZKO, Neuenburg (DE)

(21) Appl. No.: 19/161,386

(22) PCT Filed: Feb. 27, 2024
(86) PCT No.: PCT/IB2024/051856

§ 371 Date: Sep. 2, 2025

Related U.S. Application Data
(60) Provisional application No. 63/488,192, filed on Mar. 3, 2023.

(51) Int. Cl. F26B 5/06; F26B 25/16

(52) U.S. Cl. CPC F26B 5/06; F26B 25/16

(57) ABSTRACT

The present disclosure includes systems and methods for annealing bulk material in a dynamic bulk freeze drying process. In some aspects, the methods can include receiving frozen bulk material in a container (120) and annealing the frozen bulk material. In some configurations, the annealing can include heating a surface of the container (120) to a first temperature that is greater than or equal a glass transition temperature of the frozen bulk material and operating the container (120) to move.

### TECHNICAL FIELD

The present application relates generally to bulk freeze drying. More specifically, the present disclosure relates to systems and methods for annealing frozen bulk material in dynamic bulk freeze drying.

### BACKGROUND

Freeze drying, also known as lyophilization or cryodesiccation, is a process that removes a solvent or suspension medium from a product. The solvent or suspension medium may be water, though others may be used, such as alcohol. Freeze drying is particularly useful in the pharmaceutical industry, as the integrity of the product is preserved during the freeze drying process and product stability can be guaranteed over relatively long periods of time. In pharmaceuticals, the freeze dried product is ordinarily, but not necessarily, a biological substance. In a freeze drying process for removing water, the water in the product is frozen to formice and, under low vacuum conditions in a process chamber, the ice is sublimed into the vapor/gas phase.

The freeze drying of frozen bulk material can be performed by conventional shelf-type freeze dryers under static conditions utilizing lyo cakes, or by using dynamic bulk freeze drying processes where the bulk product is kept in motion, such as in a rotating drum or via vibrating shelves. In conventional, staticfreeze drying processes, the frozen bulk material is characterized by typically high porosities (e.g., from sublimation of large ice crystals). The pore diameters in the lyo cake have a significant impact on the drying process, as the vapor diffusion speed is linked to the pore diameter, with higher diffusion occurring in larger pores. Thus, large pore size is a major target in statically freeze dried products to achieve a reasonable drying time due to the associated increase in intra-particulate diffusion of the water vapor.

Annealing is a known method to modify the pore structure of frozen liquid materials by increasing the growth of ice crystals, which, when removed on sublimation, will leave larger pores in the product. Thus, annealing is utilized to enlarge the pore structure and pore size of the frozen material. The pore size, and the enlargement thereof, is the main driving force for annealing in conventional freeze-drying process and may be utilized to reduce the specific surface area (SSA), increase drying speed and reduce reconstitution time, and improve the product properties. Annealing is typically performed by raising the temperature of the frozen substrate to above the glass transition temperature (Tg′) after the initial freezing step and before the vacuum drying step.

In preparation for dynamic bulk freeze drying, frozen bulk material has to be generated. The frozen bulk material is generated during a very fast freezing step, such as spray freezing, which results in a bulk material that is characterized by significantly smaller ice crystals (and larger SSA) than that found in the material that is frozen using a conventional static process. The vapor diffusion processes in these smaller pores left by the smaller ice crystals that occur during spray freezing are different than those that occur during the static freeze drying of frozen product with the larger pores. In spray freezing small particles are generated, while much larger layers are frozen in a static manner. For example, the smaller particles have a much shorter diffusion length and can still achieve a reasonable drying time despite their smaller pore sizes. Thus, pore size, and the enlargement thereof, is not the target in dynamic freeze drying even though it happens during annealing as well.

Additionally, when subjecting frozen bulk material obtained by fast freezing processes (e.g., such as those used in dynamic freeze drying processes) to the annealing temperature range for conventional, statically frozen material (20-25 degrees Kelvin (° K) above Tg′), the flow properties of the frozen bulk material substantially decrease, resulting in a very tacky product that forms aggregates. Aggregate formation in frozen bulk material is a known phenomenon of the dynamic bulk freeze drying process, especially after intermediate storage of the frozen bulk, and such aggregates normally disintegrate within 30-120 minutes of formation. However, aggregates that form during rotary freeze drying at annealing conditions used for conventional, static lyophilization do not disintegrate during the further processing. The resulting bulk material is incapable of maintaining particle size, and these aggregate lumps fail to completely dry. This, in turn, may result in highly inhomogeneous moisture levels and bulk material that cannot be processed further. Accordingly, annealing processes for dynamic bulk freeze drying are not expected to achieve any of the benefits found in conventional, static annealing processes and, in fact, are known to decrease product properties.

### SUMMARY

The present disclosure provides apparatuses, systems, and methods for annealing frozen material in a dynamic bulk freeze drying process. Unexpectedly, the present annealing processes can reduce the specific surface area (SSA) of the frozen bulk material without producing non-disintegrable aggregates. And while the present annealing processes may not result in some of the benefits produced by annealing processes in static freeze drying (e.g., increased drying speed and reduced reconstitution time, which in any case are already significantly improved by spray freeze drying), other benefits have been found, such as the reduction of protein degradation, decreased foaming during reconstitution, or the like. For example, some of the annealing processes can result in a decreased SSA that increases protein stability and decreases reconstitution time due to lower gas adsorption on the material surfaces. Although reduction of the SSA may happen in the annealing of statically conventionally frozen products, the reduction of the SSAwas found to have a much greater effect in the dynamic freeze drying process. To illustrate, the SSA of products in conventional, static freeze drying is already relatively low so as to not produce at least some of the advantages described herein. It is also unexpected that the use of more mild parameters of the present annealing processes will lead to these beneficial effects.

The present systems and methods can be configured for annealing the frozen bulk material in a dynamic bulk freeze drying process. Some aspects of the present disclosure can include a method of freeze drying a bulk product at least by receiving frozen bulk material in a container configured for dynamic bulk freeze drying (e.g., a rotary drum or a non-rotating vessel in which frozen bulk may be stirred, tumbled, or otherwise agitated), and annealing the frozen bulk material within the container. In some configurations, annealing may include heating the bulk material, a surface of the container, or both, to a first temperature that is greater than or equal to a glass transition temperature of the frozen bulk material, and operating the container to move. During such container movement, the frozen bulk material will lose flowability over time and, in some embodiments, will become notflowable. In some configuration, the annealing steps may be performed at a pressure that is substantially equal to atmospheric conditions. In configurations involving a rotary drum as the container, the annealing can include heating a surface of the rotary drum to an annealing temperature range that is less than or equal to fifteen degrees Kelvin above a glass transition temperature of the frozen bulk material, and operating the rotary drum in a pendular mode to move at least some of the frozen bulk material. Such methods can produce a frozen bulk material with decreased SSA, as compared to traditional dynamic frozen material, that can regain flowability, including during a stage at which the container is subject to vacuum conditions and further during the drying step, and allow for disintegration of aggregates formed during the annealing step.

In a broad respect, the present methods include annealing frozen bulk material in a dynamic freeze drying process. The annealing can be followed by a flowability recovery process, a freeze drying process, or both. The resulting product may include a decreased SSA that may enhance protein stability and improve reconstitution time due to lower gas adsorption on the material surfaces. This reduction in SSA can be of a greater magnitude than any reduced SSA from a conventional, static annealing process. In a broad respect, the present systems include a vessel for annealing the frozen bulk material. The vessel (e.g., freeze drying vessel) can be used to enhance flowability of a material, or freeze dry the material in a separate location, or the same location, from where the annealing takes place.

In a broad respect, the present methods can include producing freeze-dried particles aseptically. Stated differently, the present methods can include producing freeze-dried partides under aseptic conditions. The methods can include annealing frozen bulk material in a dynamic freeze drying process. In some aspects, the method can include receiving frozen bulk material in a container and annealing the frozen bulk material. The annealing can include heating a surface of the container to a first temperature that is greater than or equal a glass transition temperature of the frozen bulk material and operating the container in a dynamic manner, such as rotating the container or otherwise moving the container or components thereof. To illustrate, the container can include a rotary drum and the annealing may include at least the steps of maintaining a temperature of a surface of the rotary drum to be within an annealing temperature range and operating the rotary drum in a pendular mode. The annealing temperature range can be from a glass transition temperature (Tg′) of the frozen bulk material to fifteen degrees Kelvin above the Tg′. In an illustrative example, the annealing temperature range can be from five to ten degrees Kelvin above the Tg′ of the frozen bulk material. In some configurations, the annealing temperature range can include a temperature at which, if maintained for a period, the individual particles the frozen bulk material are no longer movable relative to one another and, in some configurations, the first temperature range can have an upper limit that corresponds to a highest temperature that enables the product to re-gain flowability during further processing steps. In some configurations, annealing is performed for a period from fifteen minutes to six hours. The annealing may be performed at ambient or atmospheric pressure.

In some aspects, heating the surface of the container includes increasing a temperature of at least a portion of a wall of the container in a stepwise manner or, alternatively, in a continuous manner. In some configurations, the temperature of the portion of the wall is increased at a rate from ten to one-hundred twenty degrees Kelvin per hour (° K/hr). In some configurations, heating the surface of the rotary drum may include heating a fluid disposed between two walls of the rotary drum. In some aspects, after the annealing, the methods can include the further steps of decreasing a temperature of the surface of the container to a second temperature range that is below the glass transition temperature. In some of the present methods, the decreasing can include controlling a heater to decrease a temperature in the container in a stepwise manner at least until a temperature of the frozen bulk material is below the glass transition temperature. Alternatively, the decreasing can include controlling a heater to decrease a temperature in the container in a continuous manner until a temperature of the frozen bulk material is below the glass transition temperature. Some of the methods can further include subjecting the container to a vacuum; some of the methods can further include operating the container in a pendular mode while the container is subject to a vacuum. Some of the methods can further include freeze drying the frozen bulk material. In some such methods, the rotary drum can be operated in a full rotation mode during at least a portion of the freeze drying steps.

Some of the present methods can include processing the annealed material to regain flowability. Such a flowability step can be performed before a subsequent freeze drying step. In some configurations, regaining flowability can include decreasing a temperature of the surface of the container to less than the Tg′ of the frozen bulk material, generating vacuum conditions within the container, operating the rotary drum in a pendular mode, or a combination thereof.

Some of the present systems are configured for dynamically freeze drying bulk material. In some aspects, the system can include a freeze drying vessel configured to freeze dry frozen bulk material. The freeze drying vessel may include a container configured to receive frozen bulk material and a heater controllable to increase or decrease a temperature of the container. In some aspects, the container is movable and can include a mechanism (e.g., motor, actuator, or the like) for imparting movement to the container or components thereof. In some aspects, the system can include a controller in communication with the container and the heater, the controller having a processor that can execute instructions (which may be stored in memory) that cause the controller to perform operations, such as operating the freeze drying vessel in various operational states. In some configurations, the operations include operating the freeze drying vessel in a first state in which the heater is controllable to control a temperature of a surface of the container to a first temperature that is greater than or equal to a glass transition temperature of the frozen bulk material and the container is controllable to move. In some configurations, the operations include operating the freeze drying vessel in a second state; the second state may include decreasing a temperature of the surface of the container, subjecting the container to a vacuum, or freeze drying the frozen bulk material, each of which may involve movement of the container. In some configurations, the operations include operating the freeze drying vessel in a third state in which the flowability of the frozen bulk material is increased. Some of the operations can include operating the freeze dying vessel, chronologically, in the first state, the third state, and then the second state.

In some aspects, operation of the freeze drying vessel in the first state includes controlling the vacuum source to maintain the pressure within the container to be substantially equal to an ambient pressure. In some configurations, operation of the freeze drying vessel in the second state, thirst state, or both, includes controlling a heater to maintain the temperature of the surface of the container to be below the glass transition temperature of the frozen bulk material. In some configurations, operation of the freeze drying vessel in the second state, thirst state, or both, includes controlling the vacuum source to maintain the pressure within the container to be at vacuum conditions.

In some aspects, the operations may further cause the controller to operate the freeze drying vessel for a first time frame that can be from fifteen minutes to six hours. In some such operations, based on expiration of the first time frame, the operations include operating the freeze drying vessel in the second state or the third state. In some aspects, the controller may receive an input associated with one or more properties of the frozen bulk. In some such configurations, based on the input, the operations may include selecting the first temperature from a group of temperatures within an annealing temperature range from the Tg′ of the frozen bulk material to fifteen degrees Kelvin above the Tg′ and controlling the temperature of the surface of the container to be substantially equal to the first temperature or selecting a target duration within the first time frame and operating the freeze drying vessel in the first state for a time that is substantially equal to the target duration. In some of the present systems, operating the freeze drying vessel in the first state includes limiting a movement of the container along an arc having an angle that is less than or equal to 270°.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” or “approximately” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, something that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Furthermore, all numerical ranges herein should be understood to include all integers, whole or fractions, within the range, inclusive of the ends of the ranges. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. Additionally, the use of between when describing two endpoints of a numerical range should be understood to include those endpoints. For example, a disclosure of between 1 to 10 should be construed as supporting a range including 1 and including 10.

Herein, “or” is inclusive and not exclusive, unless expressly indicated otherwise or indicated otherwise by context, and can have the same meaning as “and/or.” Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Any configuration of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one configuration may be applied to other configurations, even though not described or illustrated, unless expressly prohibited by this disclosure or the nature of the configurations. Further, an apparatus or system that is configured in a certain way is configured in at least that way, but it can also be configured in other ways than those specifically described. Some details associated with the configurations described above and others are described below.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a schematic view of an example of a freeze drying system of some embodiments of the present disclosure.

FIG. 2 is a schematic box diagram of a freeze drying system of the present disclosure.

FIG. 3 illustrates a flow diagram of an example of a method of freeze drying a bulk product.

FIG. 4A illustrates a diagram of an operation of a rotary drum of the present disclosure during an annealing step of the present methods.

FIG. 4B illustrates a diagram of an operation of a rotary drum of the present disclosure during a freeze drying step of the present methods.

### DETAILED DESCRIPTION

The following description concerns the use of a freeze drying vessel that includes a rotary drum for the container configured to receive and move frozen bulk material during the present annealing. However, those of ordinary skill in the art should understand that the present annealing processes can be applied to freeze drying vessels with other containers, such as those that include vibrating shelves or belt dryers, as well as other vessels with non-rotating containers (e.g., those a container suitable or otherwise configured for stirring or tumbling frozen bulk material therein, or the like), and the same or similar benefits should follow. Additionally, those of ordinary skill in the art should understand that the structures of certain components associated with the rotary drum, such as the heater, valves, transfer sections, or the like, can change based on the specific type of container utilized for the annealing processes, described herein.

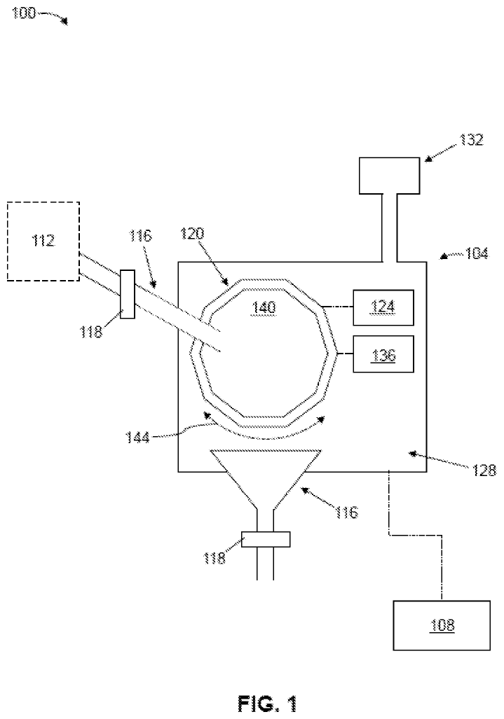

Referring now to FIG. 1, a freeze drying system 100, for freeze drying a bulk product (e.g., lyophilization), is shown. As depicted, system 100 includes a freeze drying vessel 104 configured for dynamic bulk freeze drying and a controller 108 (e.g., control system) in communication with one or more components of the freeze drying vessel 104. In some configurations, system 100 can include one or more additional components, such as a spray freezing vessel 112, one or more transfer sections 116, valves 118, or additional equipment for further processing (e.g., a secondary drying station, a packaging station, a discharge station, or other process equipment). As described herein, system 100 is configured for annealing and freeze drying afrozen bulk material and, in at least some configurations, is operable under aseptic conditions.

Freeze drying vessel 104 includes a container, in the form of rotary drum 120, configured to receive frozen bulk material and move the bulk material during the dynamic bulk freeze drying operation and a heater 124 that is configured to increase or decrease a temperature within the freeze drying vessel. However, as described herein, other containers (e.g., agitators) or heaters may be utilized to perform the processes described herein. As depicted in FIG. 1, rotary drum 120 and heater 124 can be disposed within a chamber 128 (e.g., vacuum chamber) that is connected to a vacuum source 132. In some configurations, freeze drying vessel 104 can include one or more sensors 136 in communication with controller 108 and configured to measure, calculate, or otherwise determine or detect parameters associated with operation of the freeze drying vessel. In some configurations, freeze drying vessel 104 may include or correspond to one or more components (e.g., motors, gears, shafts, bearings, plates, or the like) of the rotating drum freeze dryer described in U.S. Pat. No. 9,347,707, which is incorporated by reference herein in its entirety.

Rotary drum 120 defines an internal volume 140 that is configured to receive bulk material (e.g., from spray freezing vessel 112) and is rotatable while bulk material is within the internal volume to impart motion thereto. In some configurations, rotary drum 120 may include a double wall structure such that an inner wall defines internal volume 140 and an outer wall defines an exterior of the drum, with the inner wall being separated from the outer wall by a gap. In some such configurations, one or more components (or a portion thereof) may be disposed within the gap. Rotary drum 120 can be controllable to rotate at speeds between zero and ten revolutions per minute (rpm), such as from 0.1 to 5 rpm. In some configurations, a rotation angle of rotary drum 120 is limited (e.g., electronically, via controller 108) to operate in a pendular mode. In the pendular mode, rotary drum 120 may be prevented from completing a full rotation (i.e., 360°). In some configurations, rotary drum 120 can be controllable to, while in the pendular mode, travel back and forth (e.g., clockwise and counterclockwise) along an arc 144 that is less than or equal to 270° (e.g., less than or equal to 180, 150, 140, 130, 120, 110, 100, 90, 80, 70, 60 degrees, or less) and greater than or equal to 5°. The pendular mode can be configured (e.g., controlled) such that the back and forth rotation of rotary drum 120 does not discharge bulk material from internal volume 140.

Heater 124 is configured to transfer heat to or from bulk material within rotary drum 120. In some configurations, heater 124, or components thereof, can be positioned outside rotary drum 120 (e.g., internal volume 140) and at least partially inside chamber 128. As an illustrative example, heater 124 can include temperature control circuitry that may comprise tubing for a heating or cooling medium (e.g., silicone oil) or electrical circuitry for electrical heating or cooling, such as via Peltier elements, heating coils, microwave heating, or the like. In some such configurations, the temperature control circuitry may be thermally coupled to the walls of rotary drum 120 (e.g., disposed within the gap of the double walls of the drum) and subject to the control of controller 108. Additionally, or alternatively, heater 124 may include an infrared radiator that is positioned within rotary drum and configured to heat bulk material via radiation. Heater 124 can be configured to operate rotary drum 120 at a target temperature or temperature range (e.g., annealing temperature range, freeze drying temperature range, secondary drying range, or the like) to decrease a temperature in the rotary drum or to increase a temperature in the rotary drum. For example, heater 124 can be configured to control a temperature of a surface (e.g., inner surface) of rotary drum 120 to be within the target temperature range. In some configurations, as further described herein, heater 124 can be operable (e.g., via instructions from controller 108) to alter a temperature in the rotary drum in a stepwise or continuous manner.

Vacuum source 132 is in fluid communication with chamber 128 of freeze drying vessel 104 and configured to generate vacuum conditions within the chamber (e.g., vacuum chamber) and within internal volume 140 of rotary drum 120. In some configurations, vacuum source 132 can include a condenser and a vacuum pump and be subject to the control of controller 108 to adjust a pressure within chamber 128. For example, vacuum source 132 is controllable to reduce a pressure within chamber 128 from an ambient pressure to a target pressure range (e.g., from 10 microbar (μbar) up to 100 μbar). Although not shown, in some configurations, a vacuum valve (e.g., 118) can selectively separate chamber 128 from vacuum source 132 such that the pressure within the chamber can be controlled independent of the actuation of a vacuum pump. In such configurations, the vacuum pump of vacuum source 132 can remain operational and the valve (e.g., 118) can be actuated (e.g., via instructions from controller 108) to adjust atmospheric conditions within chamber 128.

Sensor(s) 136 may be coupled to one or more components of freeze drying vessel 104 to measure, calculate, or otherwise determine or detect parameters associated with operation of the freeze drying vessel, such as temperature, pressure, moisture content, flow characteristics of the bulk material, or the like. In some configurations, sensor 136 may comprise one or more temperature sensors, pressure sensors, humidity sensors, optical sensors (e.g., camera), timers, or the like. In some configurations, sensor 136 may include a wall temperature sensor (e.g., thermocouple) that is in contact with a surface (e.g., inner surface) of rotary drum 120. For example, the wall temperature sensor can be coupled to a metal block that is in contact with inner wall of rotary drum 120. Additionally, or alternatively, sensor 136 may include a product temperature sensor that is disposed within internal volume 140 of rotary drum 120 and is not in contact with a surface of the rotary drum. For example, the product temperature sensor can be spaced from the drum wall and configured to, while rotary drum 120 is filled with bulk material, rotate with the drum such that a sensing portion of the product temperature sensor is disposed within the bulk material at least once during a complete rotation of the drum. Sensor(s) 136 can be in communication with controller 108 and, as an example, may send control signals to the controller to store data created by the sensor(s).

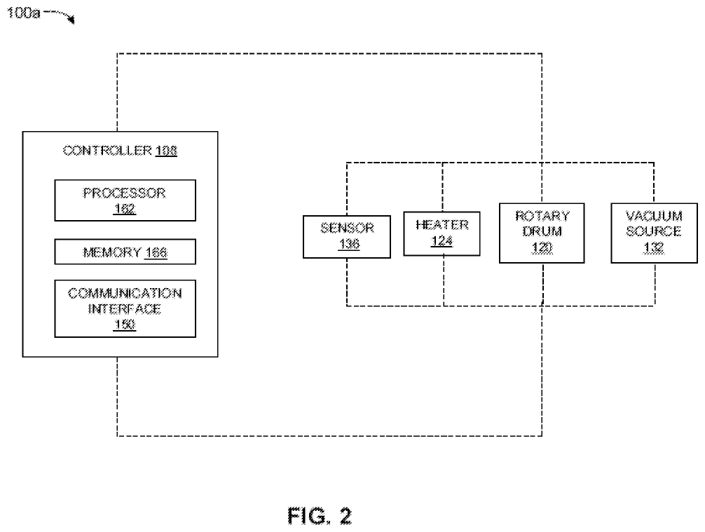

Controller 108 can be in electrical communication (e.g., wired or wireless communication) with one or more of the components of system 100 to perform one or more of the operations described herein. For example, the one or more operations may include operating the freeze drying vessel in a first state (e.g., an annealing mode) in which heater 124 is controllable to maintain a temperature of a surface of rotary drum 120 to be within a target range (e.g., an annealing temperature range), and the rotary drum is controllable to rotate in the pendular mode. In some such operations, the target range can be from a glass transition temperature (Tg′) of the frozen bulk material to a temperature above the Tg′ while at least a portion of the frozen bulk material that is in the moving drum is still in motion relative to another portion of the frozen bulk material. As the temperature increases above the Tg′, the material starts to stick together and the flowability of the material decreases. At a certain temperature threshold (e.g., flowability threshold), enough of the material sticks together such that relative movement of the individual particles within the material (e.g., frozen particles) is severely diminished. For example, the threshold may correspond to a temperature where there is no relative movement of the individual particles within the material. System 100 is configured to (e.g., the container, such as rotary drum 120, and heater 124 are controllable to) keep the frozen material below this threshold. This temperature threshold can vary based on the particular material and the selected dynamic condition(s) (e.g., pendular motion of a rotary drum; stirring of material in a suitable container; etc.), however, as an illustrative, non-limiting example, the target range can be from 5 to 15 degrees Kelvin (° K) above a glass transition temperature (Tg′) of the frozen bulk material (e.g., such as from 5 to 8° K above Tg′). This target range can be below traditional temperatures used for annealing in static processes, which typically range between 20 and 25° K. Additional operations are described in further detail, below, with reference to FIGS. 2-4.

As illustrated in FIG. 1, an upstream transfer section 116 can extend between spray freezing vessel 112 and freeze drying vessel 104 to convey frozen bulk material from the spray freezing vessel 112 to internal volume 140 of rotary drum 120. In some configurations, as described in more detail in U.S. Pat. No. 9,347,707, rotary drum 120 can be operable to discharge bulk material to a downstream transfer section 116 and can include one or more components configured to enable such operation (e.g., discharge opening, discharge baffles, inclination means, or the like). Controller 108 can be configured to control the flow of bulk material to freeze drying vessel 104. As an illustrative example, controller 108 can be configured to actuate one or more valves 118 coupled to respective transfer sections 116 to selectively enable or block flow within that transfer section, as is understood in the art. Valves 118 can be configured (e.g., valve 118 may be controlled) to seal chamber 128 from at least a portion of the transfer section (e.g., 116) to which the valve is coupled; in some configurations, the valve may include, but is not limited to, a flap gate, a lid, a butterfly valve, a squeeze valve, a knife gate valve, or the like. As described, a “seal” or “sealing” should be understood as “leakage-free” for gas, liquids, and solids, to be maintained for pressure differences of, for example, ambient conditions on one side and vacuum conditions (e.g., 6 millibar, 1 millibar, or less) on the other side.

Each transfer section 116 can be coupled to freeze drying vessel 104 (e.g., to a vessel wall) to allow for the protection of sterility or containment at the transition from the respective transfer section and the freeze drying vessel. Such coupling can be permanent (e.g., via welding) or semi-permanent (e.g., via screwing or bolting), which are intended to be permanent during production runs, cleaning, sterilization, etc., but which can be disassembled for purposes of inspection, revision, validation, etc. Sealing technologies that may be applied in conjunction with the aforementioned techniques in order to provide the prerequisite for “closed conditions” (sterile or containment conditions) include, but are not limited to, flat seals or gaskets, flange connections, and the like. Any sealing material should be absorption-resistant and should withstand low temperatures in order to avoid embrittling or attrition with risk of product pollution resulting therefrom. Adhesive bonding may also be employed as long as any adhesive is emission-free.

Referring now to FIG. 2, shown is a schematic diagram of system 100a (e.g., control system 100a). Control system 100a can include or correspond to one or more components of system 100. As depicted, control system 100a can include controller 108 (or multiple controllers 108) that is in wired or wireless communication with various components of the system (e.g., 100, 100a) in order to automatically control such components or operations of the system, such as, but not limited to, operation of the flow of bulk material through transfer sections (e.g., 116), operation of valves (e.g., 118), operation of the spray freeze vessel (e.g., 112), operation of rotary drum 120, operation of heater 124, operation of vacuum source 132, monitoring of flow parameters, chemical compositions, or the like (e.g., via sensors 136), or a combination thereof.

The controller 108 may be utilized to perform one or more steps of one or more methods described or illustrated herein. In particular configurations, the controller 108 provides the functionalities described or illustrated herein. In particular configurations, software running on the controller 108 performs one or more steps of one or more methods described or illustrated herein or provides the functionalities described or illustrated herein. Particular configurations include one or more portions of the controller 108. Herein, a reference to a controller may encompass a computing system or a computing device, where appropriate.

This disclosure contemplates the controller 108 taking any suitable physical form. As example and not by way of limitation, the controller 108 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the controller 108 may include one or more controllers 108; be unitary or distributed; span multiple locations; span multiple machines; span multiple data centers; or reside in a cloud, which may include one or more cloud components in one or more networks. Where appropriate, one or more controllers 108 may perform without substantial spatial or temporal limitation one or more steps of one or more methods described or illustrated herein. As an example, and not by way of limitation, one or more controller 108 may perform in real time or in batch mode one or more steps of one or more methods described or illustrated herein. One or more controllers 108 may perform at different times or at different locations one or more steps of one or more methods described or illustrated herein, where appropriate.

In some configurations, controller 108 may include a processor 162 (e.g., CPU) coupled to a memory 166 (e.g., a computer-readable storage device). In some configurations, the processor includes hardware for executing instructions, such as those making up a computer program. As an example, and not by way of limitation, to execute instructions, the processor may retrieve (or fetch) the instructions from memory 166; decode and execute the instructions; and then write one or more results to the memory.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, Secure Digital cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Memory 166, such as a non-transitory computer-readable storage medium, may include volatile memory devices, nonvolatile memory devices (e.g., read only memory (ROM) devices, programmable read-only memory, and flash memory), or both. Memory 166 may be configured to store instructions, one or more thresholds, one or more data sets, or a combination thereof. In some configurations, the instructions (e.g., control logic) may be configured to, when executed by the one or more processors 162, cause the processor(s) to perform one or more operations (e.g., operate freeze drying vessel 104 in one or more operational states). In some configurations, the one or more thresholds and one or more data sets may be configured to cause the processor(s) to generate control signals. For example, the processor(s) 162 may initiate and/or perform operations as described with reference to FIG. 1. As a specific example, thresholds can include a maximum (max) temperature threshold (e.g., max annealing temperature, max freeze drying temperature, or the like), pressure threshold, duration, or the like. Data sets can include data associated with thresholds or other parameters of system 100, such as, historical data (e.g., product temperature, rotary drum 120 temperature, freeze drying vessel 104 temperature, the freeze drying vessel pressure, rotation speed of the rotary drum, rotation angle of the rotary drum (e.g., along arc 144), duration of operation, temperature ramp, flow characteristics, chemical compositions, other product characteristics, or the like) from one or more previous validation cycles. In some configurations, one or more operational parameters of system 100a can be selected based on historical data.

In embodiments in which the controller 108 communicates wirelessly with one or more components of the system 100, the controller 108 may communicate over a network. As an example, and not by way of limitation, the network may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless.

In particular configurations, communication interface 150 ludes hardware, software, or both providing one or more interfaces for communication (such as, for example, packet-based communication) between controller 108 and one or more components of the system 100. In some configurations, communication interface 150 can include or correspond to one or more I/O devices. Interfaces 150 may include a network interface and/or a device interface configured to be communicatively coupled to one or more other devices. For example, interfaces 150 may include a transmitter, a receiver, or a combination thereof (e.g., a transceiver), and may enable wired communication, wireless communication, or a combination thereof, such as with an I/O device that may include, but is not limited to, a touchscreen, a display device, a light emitting diode (LED), a speaker, a microphone, acamera, keyboard, computer mouse, another I/O device, or any combination thereof, as illustrative, non-limiting examples. Some of the operations described herein may be performed in response to an input from interface 150.

System 100a can include one or more sensor(s) 136 configured to detect one or more parameters (e.g., temperature, pressure, humidity, or the like) and to provide data to controller 108 (e.g., via a control signal). In some configurations, circuitry (e.g., a PCB, wires, etc.) may connect components of control system 100a with one or more other components of the system. Sensor(s) 136 may be coupled to one or more components of system 100a—including spray freezing vessel 112, transfer sections 116, rotary drum 120, chamber 128, freeze drying vessel 104, vacuum source 132, or the inlets and outlets thereof, or any other portions of the system. In some configurations, sensor(s) 136 are configured to determine parameters associated with a bulk material (e.g., frozen product) within freeze drying vessel 104. For example, sensor(s) 136 can be configured to measure, detect, or determine a temperature of bulk material within rotary drum 120, a temperature of a surface of a wall of the rotary drum, a temperature within chamber 128 of freeze drying vessel 104, a combination thereof, or the like. In some aspects, sensor(s) 136 may comprise a pressure sensor, a temperature sensor, a weight sensor, a mass flow sensor, an ultrasonic sensor, a level sensor, an infrared sensor, an accelerometer, a humidity sensor, or other suitable sensor.

Controller 108 can be configured to generate and send control signals (e.g., in response to receiving an input, such as from interface 150 or sensors 136), receive control signals from other components, or otherwise communicate with the components of system 100a to perform the operations described herein. As an illustrative example, the operations may include annealing the frozen bulk material. In an illustrative example, annealing the frozen bulk material can include operating freeze drying vessel 104 in a first state, in which heater 124 is controlled to maintain a temperature of a surface of the rotary drum to be within an annealing temperature range (e.g., from 5 to 15° K above Tg′ of the bulk material), and causing (or otherwise controlling) rotary drum 120 to rotate in a pendular mode (e.g., from 5 to 180° along arc 144). The one or more operations may include operating heater 124 in a specific manner, such as a in a stepwise, continuous, or instantaneous manner, as described further herein. In some configurations, operation of freeze drying vessel 104 in the first state can include actuating vacuum source 132 (or a vacuum valve) to maintain a pressure within the freeze drying vessel (e.g., chamber 128, internal volume 140) at ambient or atmospheric conditions. In some configurations, the one or more operations may include maintaining operation of freeze drying vessel 104 in the first state for a target duration, such as a time period from 15 minutes to 6 hours (e.g., from one to six hours).

The one or more operations may also include freeze drying the frozen bulk material. For example, in some configurations, freeze drying the bulk material may include operating freeze drying vessel 104 in a second state, in which the frozen bulk material is freeze dried. In an illustrative example, operation of freeze drying vessel 104 in the second state can include controlling heater 124 to maintain the temperature of the surface of rotary drum 120 to be below the glass transition temperature of the frozen bulk material or controlling vacuum source 132 to maintain a pressure within the freeze drying vessel (e.g., chamber 128, internal volume 140) at vacuum conditions, such as less than or equal to 1 millibar, 500 microbar, or 1 microbar. The one or more operations may also include improving flowability of the bulk material (e.g., disintegrating aggregates formed during the annealing step). For example, in some configurations, improving flowability of the bulk material may include operating freeze drying vessel 104 in a third state, such as one in which the flowability of the frozen bulk material is increased. Some of the operations can include operating the freeze dying vessel, chronologically, in the first state, the third state, and then the second state.

In some configurations, the one or more operations may include switching operation states of freeze drying vessel 104. To illustrate, an operation can include setting freeze drying vessel 104 to the first state, maintaining operation in the first state for a first time frame (e.g., from 1 to 6 hours), and, based on expiration of the first time frame, switching the operating state of the freeze drying vessel (e.g., to a second, a third, or other state). For example, the one or more operations may include, after expiration of the first time frame, operating freeze drying vessel 104 in the second state for a second time period to regain flowability. In some such configurations, the one or more operations may include, after expiration of the second time frame, operating freeze drying vessel 104 in the third state for a third time period to freeze dry the bulk material. Although operations are described with respect to freeze drying vessel 104, some configurations can include transferring the bulk material to other vessels and operating those other vessels in the operational states described herein.

Some of the operations may include decreasing a pressure or increasing a temperature of freeze drying vessel 104 (e.g., surface of rotary drum 120) to be at a target temperature or within an annealing range associated with the bulk material. Additionally, or alternatively, the operations may include increasing a pressure or decreasing a temperature of freeze drying vessel 104 to be at a target temperature or within a freeze drying range associated with the bulk material. Such operations may be in response to a chemical composition of the bulk material or other parameters of the bulk material (e.g., glass transition temperature, melting point, boiling point, sublimation temperature, triple point, critical point, other transition temperatures or pressures, other thermodynamic properties, or the like). For example, the controller may perform the operation of selecting a target temperature that is within an annealing temperature range and controlling heater 124 such that a temperature of the surface of rotary drum 120 is substantially equal to the target temperature. Additionally, or alternatively, the controller may perform the operation of selecting a target duration and operating freeze drying vessel 104 in the first state for a time that is substantially equal to the target duration. Additionally, or alternatively, the controller may perform the operation of selecting a thermal ramp (e.g., to the rate (change of temperature per unit of time) at which heater 124 transitions a temperature of freeze drying vessel 104). To further illustrate, the operations can include selecting or adjusting a type of thermal ramp (e.g., stepwise, continuous, or instantaneous temperature change) or a magnitude (e.g., a ramp rate) of the thermal ramp.

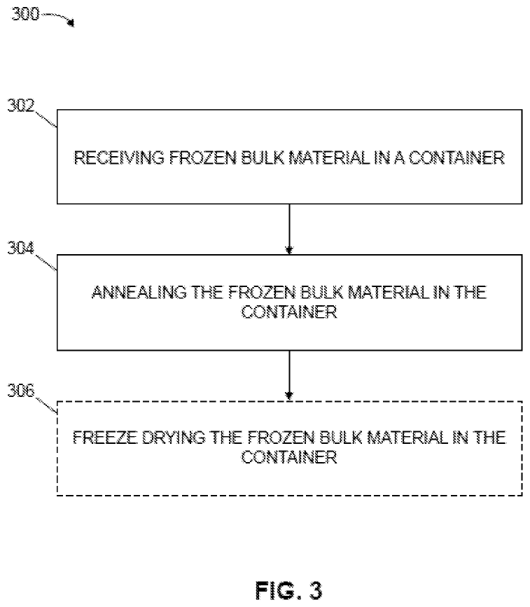

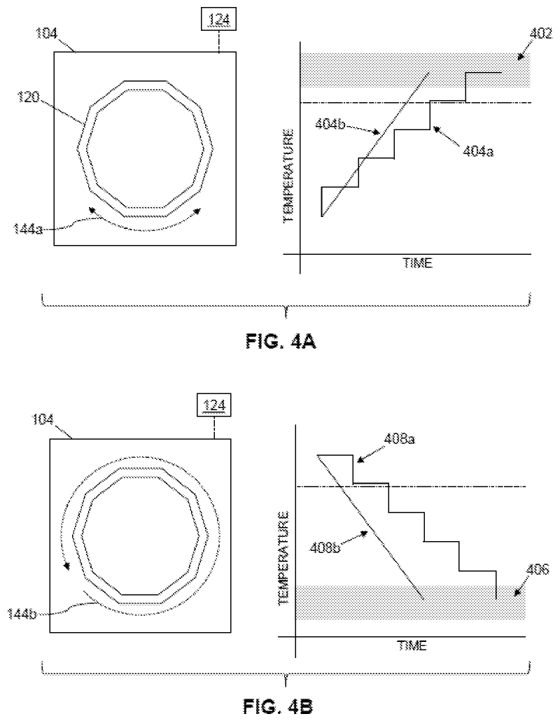

Referring now to FIGS. 3, 4A and 4B, a method 300 of freeze drying a bulk product is shown. In some configurations, the freeze drying may occur under aseptic conditions. Method 300 can be performed by or at system 100, 100a. Although the example method 300 is described with reference to the flowchart illustrated in FIG. 3, it will be appreciated that other ways of performing the acts associated with the method 300 may be used in view of the preceding description.

As shown, method 300 includes receiving frozen bulk material in a container (e.g., rotary drum 120), at step 302. In some configurations, the receiving can include actuating spray freezing vessel 112 or valves 118 to deliver the bulk material to internal volume 140 of rotary drum 120 (e.g., via transfer section 116).

Method 300 further includes annealing the frozen bulk material, at step 304. The annealing can be performed within rotary drum 120, as described herein, or within another dynamic bulk freeze drying container, as discussed herein. Annealing the frozen bulk material can include heating a surface of rotary drum 120 to a first temperature that is greater than or equal a glass transition temperature of the frozen bulk material. In an illustrative example, the bulk material, container (e.g., surface of rotary drum 120), or both can be heated to a first temperature range 402 (e.g., an annealing temperature range). In some configurations, first temperature range 402 can include a temperature at which, if maintained for a period, the individual particles the frozen bulk material are no longer movable relative to one another and, in some configurations, the first temperature range can have an upper limit that corresponds to a highest temperature that enables the product to re-gain flowability during further processing steps (e.g., when the product/drum temperatures are lower and a vacuum is pulled in the freeze drying vessel). In a non-limiting example, first temperature range 402 can include a range that is less than or equal to fifteen degrees Kelvin above a glass transition temperature (Tg′) of the frozen bulk material and greater than or equal to the Tg′. In some methods, annealing the frozen bulk material can include operating container to move at least some of the frozen bulk material. In a particular configuration, the annealing may include operating rotary drum 120 in a pendular mode. For example, an illustrative schematic of an example of the annealing process, at step 304, is depicted in FIG. 4A with respect to rotary drum 120. In some configurations, the annealing may be performed at atmospheric conditions. Some methods can include a step of determining the glass transition temperature of the material, such as via differential scanning calorimetry, as is known in the art.

Referring now to FIG. 4A, heating a surface of rotary drum 120 can be performed in a stepwise manner, as shown by line 404a, or in a continuous manner, as shown by line 404b, until a temperature of the surface of the rotary drum is within first temperature range 402. First temperature range 402 may span from a glass transition temperature of the bulk material to 18° K above the glass transition temperature (e.g., from 3, 5, or 7° K to 8, 10, 12, or 15° K of the glass transition temperature, or any range therebetween). In some configurations, the annealing includes maintaining the temperature of the rotary drum 120 (or bulk material therein) at a target temperature for a target duration. In some configurations, heating the surface of the rotary drum includes heating a fluid (e.g., silicone oil disposed within (e.g., disposed within tubing within) a double wall of the rotary drum). In some configurations, the heating may not include radiative heating (e.g., from an infrared source).

The stepwise heating (e.g., 404a) includes increasing the temperature of heater 124 (or objects in thermal communication with the heater, such as the bulk product or walls of rotary drum 120) at a first rate and at a second rate in an alternating sequence. The first rate is greater than the second rate so as to form a step or stair-like pattern as shown in the temperature chart of FIG. 4B. The first rate can have a slope (i.e., change in temperature over change in time) that is greater than one and may include or correspond to a rate of the heater when operating in an instantaneous manner. The second rate can have a slope that is less than one and can include a slope of zero such that the temperature is maintained during the second rate. The stepwise heating (e.g., 404a) can be performed until the temperature reaches the target temperature. The first rate, second rate, and durations thereof can be controlled such that an average slope of the heating is equal to or between 10 and 120 Δ° K/hour.

The continuous heating (e.g., 404b) includes increasing the temperature of heater 124 (or objects in thermal communication with the heater, such as the bulk product or walls of rotary drum 120) at a substantially constant rate (e.g., rate is maintained within ten percent (10%) during heating). The continuous heating (e.g., 404b) can occur gradually such that heater 124 is increased at a rate (e.g., having a slope from ten to 120 Δ° K/hour) that is less than its maximum heating rate of the heater (e.g., less than 80% of the maximum heating rate). The continuous heating (e.g., 404b) can be performed until the temperature reaches the target temperature. In this way and others, rotary drum 120 or bulk material within internal volume 140 can be heated to a target temperature (e.g., 5, 6, 7, or 8° K) within first temperature range 402. Such heating can be controlled to improve one or more properties of the resulting lyophilized product as compared to instantaneous heating.

As further depicted in FIG. 4A, operating the rotary drum in a pendular mode can include rotating rotary drum 120 along an arc 144a that is less than 270 degrees. For example, arc 144a may be less than or equal to 180°(e.g., less than or equal to 150, 140, 130, 120, 110, 100, 90, 80, 70, 60 degrees, or less) and greater than 5°. In some configurations, the operating the rotary drum in a pendular mode can include rotating drum 120 in a first direction (e.g., clockwise) and upon reaching an end of the arc path (e.g., a rotation threshold), rotating the drum in a second direction (e.g., counterclockwise). In some such configurations, the pendular mode included rotating rotary drum 120 in the first and second directions in an alternating manner. The annealing step can decrease flowability of the bulk material such that the material clumps together and may stick to the walls of rotary drum 120. Limiting the rotation of rotary drum 120 to that of arc 144a can prevent material that is stuck to the walls of rotary drum 120 from becoming inverted and falling from the wall in an uncontrolled manner.

After the annealing, the temperature of the surface of the rotary drum can be decreased to a second temperature range that is below the glass transition temperature. The second temperature range can be associated with a flowability process or a freeze drying process. For example, method 300 can include freeze drying the frozen bulk material in the container (e.g., rotary drum 120), at step 306 of FIG. 3. Freeze drying the frozen bulk material can include heating the bulk material, the container (e.g., a surface of rotary drum 120), or both to a second temperature range 406 (e.g., freeze drying temperature range) that is less than the glass transition temperature of the frozen bulk material. As used herein, the term “heating” means altering a temperature, which includes both increasing and decreasing the temperature. In some configurations, freeze drying can include operating the rotary drum in a full rotational mode to move at least some of the frozen bulk material. Additionally, or alternatively, the freeze drying can include decreasing a pressure within the container to be at vacuum conditions. In some configurations, the freeze drying can be performed at vacuum conditions. An illustrative schematic of an example of the freeze drying process, of step 306, is depicted in FIG. 4B with respect to rotary drum 120.

Referring now to FIG. 4B, cooling a surface of rotary drum 120 can be performed to decrease the surface temperature in a stepwise manner, as shown by line 408a, or in a continuous manner, as shown by line 408b, until a temperature of the surface of the rotary drum is within second temperature range 406. Stepwise lines 408a and continuous lines 408b can be the same as lines 404a and 404b, respectively, except that the temperature of the object is being decreased (i.e., slope of rate is negative). In some configurations, a relative temperate rate of the lines 408a, 408b can be greater than or less than the corresponding rates of lines 404a, 404b, respectively. As further depicted in FIG. 4B, operating the rotary drum in a full rotational mode can include rotating rotary drum 120 along an arc 144b that is equal to 360 degrees. In some such configurations, the operating the rotary drum in the full rotational mode can include rotating rotary drum 120 in only a first direction (e.g., counterclockwise). In some configurations, rotary drum 120 is not operating in the full rotational mode until the flowability of the bulk material is restored. For example, before freeze drying the bulk material, the present methods (e.g., 300) can include restoring the flowability of the bulk material that may include cooling a surface of rotary drum 120 to a conditioning temperature range that is less than the glass transition temperature of the frozen bulk material and operating the rotary drum in the pendular mode at vacuum conditions. Upon restoring the flowability, rotary drum 120 can then be operated at the full rotational mode.

As described herein, some of the present methods can include charging of a freeze dryer (e.g., 104) with product (e.g., spray frozen product), heating a container (e.g., drum 120) to a target annealing temperature, maintaining a temperature of the product for a target period, cooling the container, generating vacuum conditions within the container, freeze-drying the product, or a combination thereof. In an illustrative example of such a method in which the container takes the form of a rotary drum (e.g., 120), the drum can be operated in the pendular mode during heating of the drum as the product looses flowability with the increasing temperature. In some such methods, the product can have no flowability (e.g., no relative movement) during at least a portion of the target period or during cooling of the drum after the target period. In some methods, the drum can be operated in the pendular mode during the cooling of the drum or during the operation at vacuum conditions as the product begins to recover flowability. In some methods, after flowability of the product is regained, the freezing cycle can be performed as normal, and the drum may operate in the full rotational mode. Although, method 300 is described for a single freeze drying vessel (e.g., 104), it should be understood that such methods can be performed in systems having two or more vessels. Further, it should be understood that other methods of the present disclosure can perform steps, including or omitting some of the steps of the method shown in FIG. 3. For example, the above processes (e.g., annealing process, flowability process, freeze drying process, or the like) can be performed at certain pressures, such as ambient or vacuum conditions. The methods described herein may include steps to achieve such conditions within freeze drying vessel 104 (e.g., such as actuating vacuum source 132) or other vessels or containers as understood in the art. Moreover, in other configurations of the present systems, and methods, multiple process lines represented by the components of system 100 shown in FIG. 1 may be running in parallel and under the control of a common control system, like controller 108.

The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus-or step-plus-function limitations, unless such a limitation is explicitly recited in a given claim using the phrase(s) “means for” or “step for,” respectively.

1. A method of freeze drying a bulk product, comprising:
receiving, in a container, frozen bulk material;
annealing the frozen bulk material, at least by:
heating a surface of the container to a first temperature that is greater than or equal a glass transition temperature of the frozen bulk material; and
operating the container to move.

2. The method of claim 1, wherein:
the container includes a rotary drum; and
the annealing includes:
maintaining a temperature of a surface of the rotary drum to be within an annealing temperature range that includes the first temperature and is from the glass transition temperature of the frozen bulk material to fifteen degrees Kelvin above a glass transition temperature of the frozen bulk material; and
operating the rotary drum in a pendular mode.

3. The method of any of claims 1-2, wherein the heating the surface of the container includes increasing a temperature of at least a portion of a wall of the container in a stepwise manner.

4. The method of any of claims 1-2, wherein the heating the surface of the container includes increasing a temperature of at least a portion of a wall of the container in a continuous manner and wherein the temperature of the portion of the wall is increased at a rate from ten to one-hundred twenty degrees Kelvin per hour (° K/hr).

5. The method of any of claims 1-4, further comprising, after the annealing:
decreasing a temperature of the surface of the container to a second temperature range that is below the glass transition temperature.

6. The method of claim 5, wherein the decreasing includes controlling a heater to decrease a temperature in the container in a stepwise manner at least until a temperature of the frozen bulk material is below the glass transition temperature.

7. The method of claim 5, wherein the decreasing includes controlling a heater to decrease a temperature in the container in a continuous manner until a temperature of the frozen bulk material is below the glass transition temperature.

8. The method of any of claims 1-7, further comprising:
freeze drying the frozen bulk material; and
wherein the freeze drying comprises operating the rotary drum in a full rotation mode.

9. The method of any of claims 1-8, wherein the annealing is performed for fifteen minutes to six hours.

10. The method of any of claims 2-9, wherein the annealing temperature range is from five to ten degrees Kelvin above the glass transition temperature.

11. The method of any of claims 1-10, wherein the heating the surface of the rotary drum includes heating a fluid disposed between two walls of the rotary drum.

12. The method of any of claims 1-11, wherein the annealing is performed at ambient pressure.

13. The method of any of claims 8-11, further comprising increasing flowability of the frozen bulk material after the annealing at least by decreasing a temperature of the surface of the container to a third temperature range that is below the glass transition temperature.

14. The method of claim 13, wherein the increasing flowability is performed at a pressure less than 6 millibar, or the freeze drying is performed at a pressure less than 6 millibar.

15. The method of claim 13, wherein:
during at least a portion of the annealing, individual particles of the frozen bulk material are no longer movable relative to one another;
during at least a portion of the increasing flowability, at least a portion of the individual particles are moveable relative to one another; and
the increasing flowability is performed prior to the freeze drying.

16. A system for freeze drying a bulk material, the system comprising:
a freeze drying vessel configured to freeze dry frozen bulk material, the freeze drying vessel including:
a container configured to receive frozen bulk material; and
a heater controllable to increase or decrease a temperature of the container; and
a controller in communication with the container and the heater, the controller having a processor that can execute instructions that cause the controller to:
operate the freeze drying vessel in a first state in which:
the heater is controllable to control a temperature of a surface of the container to a first temperature that is greater than or equal to a glass transition temperature of the frozen bulk material;
the container is controllable to move; and
operate the freeze drying vessel in a second state in which the frozen bulk material is freeze dried.

17. The system of claim 16, wherein the operating the freeze drying vessel in the second state includes controlling a heater to maintain the temperature of the surface of the container to be below the glass transition temperature of the frozen bulk material.

18. The system of any of claims 16-17, wherein the instructions, when executed by the processor, further cause the controller to:
operate the freeze drying vessel in a third state to regain flowability of the frozen bulk material, which includes controlling a vacuum source coupled to the freeze drying vessel to decrease a pressure within the container to be less than or equal to 6 microbar; and
operate the freeze dying vessel, chronologically, in the first state, the third state, and then the second state.

19. The system of any of claims 16-18, wherein the operating the freeze drying vessel in the first state includes controlling the vacuum source to maintain the pressure within the container to be substantially equal to an ambient pressure.

20. The system of any of claims 16-19, wherein:
the instructions, when executed by the processor, further cause the controller to operate the freeze drying vessel for a first time frame; and
the first time frame is from fifteen minutes to six hours.

21. The system of any of claims 16-20, wherein, the instructions, when executed by the processor, further cause the controller to, based on expiration of the first time frame, operate the freeze drying vessel in the second state.

22. The system of any of claims 16-21, wherein the instructions, when executed by the processor, further cause the controller to:
receive an input associated with one or more properties of the frozen bulk material; and based on the input:
select the first temperature from a group of temperatures within an annealing temperature range from the glass transition temperature of the frozen bulk material to fifteen degrees Kelvin above a glass transition temperature of the frozen bulk material and control the temperature of the surface of the container to be substantially equal to the first temperature; or
select a target duration within the first time frame and operate the freeze drying vessel in the first state for a time that is substantially equal to the target duration.

23. The system of any of claims 16-21, wherein the instructions, when executed by the processor, further cause the controller to, while operating the freeze drying vessel in the first state, limit a movement of the container along an arc having an angle that is less than or equal to 270°.
